(19) United States
(12) Patent Application Publication
(10) Pub. No.: US 2014/0327345 A1
(43) Pub. Date: Nov. 6, 2014

(54) NOISE SHIELD UNIT IN WOUND ROTOR SYNCHRONOUS MOTOR (WRSM) MOTOR

(71) Applicant: Hyundai Motor Company, Seoul (KR)

(72) Inventors: Dongyeon HAN, Seoul (KR); Myeong Kyu JUNG, Seoul (KR); Young Jin SEO, Yongin-si (KR); Hyoungjun CHO, Seoul (KR); Kyoungbum KIM, Yongin-si (KR)

(73) Assignee: Hyundai Motor Company, Seoul (KR)

(21) Appl. No.: 14/144,200

(22) Filed: Dec. 30, 2013

(30) Foreign Application Priority Data
May 3, 2013 (KR) 10-2013-0049962

(51) Int. Cl. H02K 11/02

(52) U.S. Cl. CPC H02K 11/026
USPC 310/68 B

(57) ABSTRACT

A noise shield unit in a WRSM drive motor has a rotor wound with coils with a slip ring disposed thereon. A brush is mounted to a brush holder to be in contact with the slip ring, and a position sensor is mounted to an end portion of the rotor. The noise shield unit may include a shield plate of a magnetic material mounted between the brush holder and the position sensor.

### CROSS-REFERENCE TO RELATED APPLICATION

This application claims the benefit of priority to Korean Patent Application No. 10-2013-0049962 filed in the Korean Intellectual Property Office on May 3, 2013, the entire contents of which are incorporated herein by reference.

### TECHNICAL FIELD

The present disclosure relates to a wound rotor synchronous motor (WRSM) drive motor. More particularly, the present disclosure relates to a noise shield unit in a WRSM drive motor for minimizing a noise shield distance of position sensor noise.

### BACKGROUND

In general, a hybrid vehicle or an electric vehicle known as an environment-friendly vehicle mostly is driven by an electric motor (hereinafter, “drive motor”) which obtains a torque from electrical energy.

The hybrid vehicle runs in an electric vehicle (EV) mode in which power is driven by the drive motor only, or in a hybrid electric vehicle (HEV) mode in which torques from both an engine and the drive motor are used. The electric vehicle generally runs by using power of a torque from the drive motor. The drive motor, which is used as a power source of the environment-friendly vehicle, typically uses a permanent magnet type synchronize motor (PMSM). The PMSM maximizes performance of the permanent magnet in a limited layout condition.

In the permanent magnet, neodymium (Nd) improves an intensity of the permanent magnet, and dysprosium (Dy) improves a high temperature demagnetization resistance. However, such rare earth metals Nd and Dy embedded in the permanent magnet are limited to some of countries, such as the China. Also, Nd and Dy are very expensive and have big price fluctuations.

Recently, in order to improve above mentioned problems, though application is under examination, an induction motor for the hybrid vehicle has been developed. However, the induction motor has a limitation in a size increase, such as a volume and a weight in order to produce comparable performance to the PMSM.

A wound rotor synchronous motor (WRSM) drive motor has been developing to replace the PMSM as the drive motor of the environment-friendly vehicle.

The WRSM drive motor can produce comparable performance to the PMSM with a volume increase of about 10%, in which a rotor of the WRSM drive motor having coils wound thereon is electromagnetized by applying a current thereto.

The WRSM drive motor requires a brush (In general, the brush is called as a slip ring type brush in this field of industry) for applying the current to the rotor coils and a position sensor, such as a resolver, for detecting an absolute position of the rotor.

The position sensor (the resolver or the like) of the drive motor detects the absolute position of the motor rotor with an output signal of an AC low voltage (about 0.5-5 Vrms). However, if there is an inflow of an external noise to the position sensor, the output signal of the sensor is distorted by the noise, which results in deterioration of sensing precision, affecting a control performance of the motor.

For an example, the WRSM drive motor has a magnetic flux by the current from the brush inflowing to the position sensor causing electromagnetic noise. That is, the WRSM drive motor may have a main flux and the output signal of the position sensor distorted by the flux generated by a brush DC current.

Therefore, though it is required to secure an adequate physical noise shield distance between the brush and the position sensor for minimizing the magnetic flux inflowing to the position sensor, an increased total length of the drive motor with an increased secured shield distance may increase the size and the weight of the drive motor.

The above information disclosed in this Background section is only for enhancement of understanding of the background of the disclosure, and therefore it may contain information that does not form the prior art that is already known in this country to a person of ordinary skill in the art.

### SUMMARY

An exemplary embodiment of the present disclosure provides a noise shield unit in a WRSM drive motor which can minimize a noise shield distance between a WRSM drive motor and a brush while shielding a noise magnetic flux inflowing to a position sensor, effectively.

According to an exemplary embodiment of the present disclosure, a noise shield unit in a WRSM drive motor has a rotor wound with coils with a slip ring disposed thereon. A brush is mounted to a brush holder to be in contact with the slip ring, and a position sensor is mounted to an end portion of the rotor. The noise shield unit may include a shield plate of a magnetic material mounted between the brush holder and the position sensor.

In the noise shield unit, the shield plate may be one unit with the brush holder.

The shield plate and the brush holder may be insert injection molded.

The shield plate may include a connection portion connected to an upper side of the brush holder. A shielding portion is connected to the connection portion as one unit spaced apart from the brush holder by the connection portion to surround the brush holder between the position sensor and the brush holder.

The shielding portion may include a first flat portion and a second portion bent toward both sides of the brush holder from both sides of the first portion, respectively.

The shield plate may be formed of S45C material.

The noise shield unit in a WRSM drive motor in accordance with an exemplary embodiment of the present disclosure can reduce a size and a weight of the entire motor assembly by applying the shield plate of a magnetic material between the brush holder and the position sensor of the WRSM drive motor to minimize the noise shield distance between the brush and the position sensor.

The noise shield unit in a WRSM drive motor in accordance with an exemplary embodiment of the present disclosure can improve a shielding performance against the noise magnetic flux generated by the DC current applied to the brush and inflowing to the position sensor effectively by disposing the shield plate between the brush and the position sensor with the same shield distance both from the brush and the position sensor.

Furthermore, a boss structure for fastening the shield plate to the motor housing, a bolting hole in the shield plate, and a process for assembling the motor housing and the shield plate for fastening the shield plate to the motor housing, together with the bolt can be eliminated.

Therefore, the noise shield unit in a WRSM drive motor in accordance with an exemplary embodiment of the present disclosure can improve assemblability of the motor assembly and reduce a production cost of the motor assembly.

### BRIEF DESCRIPTION OF THE DRAWINGS

The attached drawings illustrate exemplary embodiments of the present disclosure, provided for describing the present disclosure in more detail, but not for limiting technical aspects of the present disclosure.

FIG. 1 illustrates a perspective view showing a noise shield unit in a WRSM drive motor in accordance with an exemplary embodiment of the present disclosure.

FIG. 2 illustrates a plan view showing a noise shield unit in a WRSM drive motor in accordance with an exemplary embodiment of the present disclosure, schematically.

FIG. 3 illustrates a perspective view showing an integrated structure of a brush holder and a shield plate applied to a noise shield unit in a WRSM drive motor in accordance with an exemplary embodiment of the present disclosure.

### DETAILED DESCRIPTION OF THE EMBODIMENTS

The present disclosure will be described more fully hereinafter with reference to the accompanying drawings, in which exemplary embodiments of the disclosure are shown so that a person skilled in this field of art can carry out. As those skilled in the art would realize, the described embodiments may be modified in various different ways, all without departing from the spirit or scope of the present disclosure.

Parts not relevant to description of the present disclosure will be omitted for clarity of the description, and the same reference numbers will be given to identical or similar constituent elements throughout the specification.

As a thickness or a size of an element in a drawing can be shown at discretion of a designer for convenience of description, the present disclosure will not be limited by those illustrated in the drawings, and the thickness is shown enlarged for showing different parts and regions, clearly.

Though terms including ordinal numbers, such as first or second, can be used for describing various elements, the elements are not confined by the terms in light of an order in description of the specification necessarily, and are used only for making one element distinctive from other elements.

In addition, throughout the specification, unless explicitly described to the contrary, the word “comprise” and variations such as “comprises” or “comprising” will be understood to imply the inclusion of stated elements but not the exclusion of any other elements.

Terms described in the specification, such as “ . . . unit”, “ . . . means,” “ . . . part,” and “ . . . member” imply a unit of a comprehensive configuration having at least one function or operation.

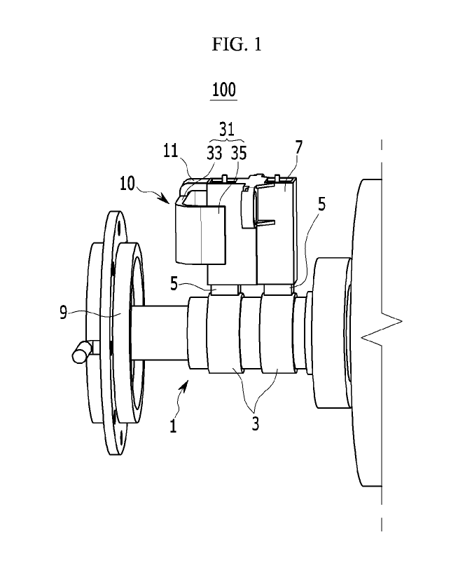

FIG. 1 illustrates a perspective view showing a noise shield unit in a WRSM drive motor in accordance with an exemplary embodiment of the present disclosure.

Referring to FIG. 1, the noise shield unit 100 in a WRSM drive motor in accordance with an exemplary embodiment of the present disclosure may be applied to the WRSM drive motor as a drive motor for obtaining a drive torque with electrical energy in an environment-friendly vehicle.

For an example, the WRSM drive motor may have a rotor wound with coils for magnetizing the rotor upon application of a current thereto, to generate a driving torque with attractive force and repulsive force between an electromagnet of the rotor and an electromagnet of a stator.

The WRSM drive motor has a rotor 1 wound with coils having a slip ring 3 disposed thereon and a brush 5 in contact with the slip ring 3 mounted to a brush holder 7. The brush holder 7 has the brush 5 supported therein elastically, for making the brush 5 to be in close contact with the slip ring 3 with the elastic force. The brush holder 7 applies the current to the rotor coil which is elastically supported with a supporting spring (not shown), and the brush 5 protrudes to an outside of the brush holder 7.

A position sensor 9, such as a resolver or the like, is disposed at an end portion of the rotor 1 opposite to the brush holder 7, for detecting an absolute position of the rotor 1. The position sensor 9 can generate an output signal of an unstable low voltage when a noise magnetic flux caused by the current applied to the brush 5 inflows thereto.

Since a basic configuration of the WRSM drive motor is an art known to persons skilled in this field of industry widely, detailed description of which will be omitted from this specification.

A shield plate 10 is mounted between the brush holder 7 and the position sensor 9 to minimize a noise shield distance between the brush 5 and the position sensor 9, thereby effectively preventing the noise magnetic flux inflowing to the position sensor 9.

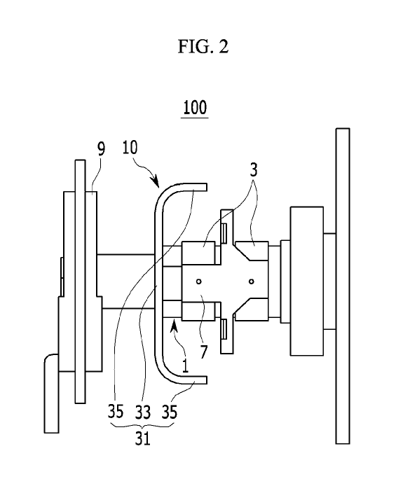

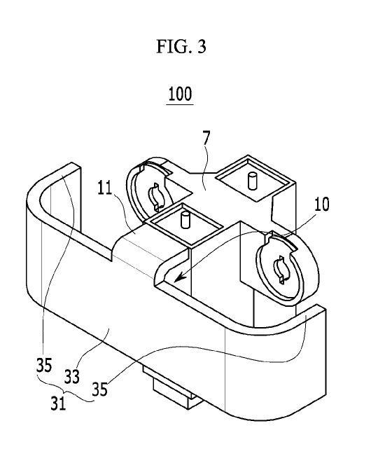

FIG. 2 illustrates a plan view showing a noise shield unit in a WRSM drive motor in accordance with an exemplary embodiment of the present disclosure schematically, and FIG. 3 illustrates a perspective view showing an integrated structure of a brush holder and a shield plate applied to a noise shield unit in a WRSM drive motor in accordance with an exemplary embodiment of the present disclosure.

Referring to FIGS. 1 to 3, the shield plate 10 according to an exemplary embodiment of the present disclosure is a plate of a magnetic material, such as S45C, which may be disposed between the brush holder 7 and the position sensor 9. The shield plate 10 may be disposed between the brush holder 7 and the position sensor 9 integrated with the brush holder 7. For an example, the shield plate 10 and the brush holder 7 may be formed as one unit by insert injection molding.

In detail, the shield plate 10 according to an exemplary embodiment of the present disclosure includes a connection portion 11 connected to the brush holder 7, and a shielding portion 31 connected to the connection portion 11 as one unit. The connection portion 11 has a fixed width connected to an upper side middle portion of the brush holder 7 as one unit connected to the shielding portion 31. The connection portion 11 has a shape bent downward toward the position sensor 9 from the brush holder 7.

As described above, the shielding portion 31, provided for shielding the noise magnetic flux substantially, is connected to the connection portion 11 as one unit. That is, the connection portion 11 may be connected to an upper side of middle of the shielding portion 31. The shielding portion 31 may further be spaced apart from the brush holder 7 by the connection portion 11 to surround the brush holder 7 between the position sensor 9 and the brush holder 7.

The shielding portion 31 includes a first flat portion 33, and a second portion 35 bent toward both sides of the brush holder 7 from both sides of the first portion 33, respectively.

The noise shield unit 100 in a WRSM drive motor in accordance with an exemplary embodiment of the present disclosure minimizes the noise shield distance between the brush 5 and the position sensor 9 owing to the shield plate 10 of the magnetic material disposed between the brush holder 7 and the position sensor 9 of the WRSM drive motor. Since the noise shield unit in a WRSM drive motor in accordance with an exemplary embodiment of the present disclosure can minimize the noise shield distance between the brush 5 and the position sensor 9, the size and the weight of the entire motor assembly can be reduced.

The noise shield unit in a WRSM drive motor in accordance with an exemplary embodiment of the present disclosure can improve a shielding performance against the noise magnetic flux generated by the DC current applied to the brush 5 and the noise magnetic flux inflowing to the position sensor 9 about 400% by disposing the shield plate 10 between the brush 5 and the position sensor 9 with the same shield distance from the brush 5 and the position sensor 9.

Furthermore, the integration of the shield plate 10 with the brush holder 7 in accordance with an exemplary embodiment of the present disclosure eliminates a boss structure for fastening the shield plate 10 to the motor housing, a bolting hole in the shield plate, and a process for assembling the motor housing and the shield plate for fastening the shield plate 10 to the motor housing, together with the bolt. Thus, the noise shield unit in a WRSM drive motor in accordance with an exemplary embodiment of the present disclosure improves assemblability of the motor assembly and reduces a production cost of the motor assembly.

While this disclosure has been described in connection with what is presently considered to be practical exemplary embodiments, it is to be understood that technical aspects of the present disclosure are not limited to the exemplary embodiment suggested in the specification, but, though a person of an ordinary skill in this field of art who understand the technical aspects of the present disclosure can suggest another exemplary embodiment by modifications, changes, removal, and addition of constituent elements within a range of technical aspects the same with the present disclosure, it may also be within a range of right of the present disclosure.

What is claimed is:

1. A noise shield unit in a WRSM drive motor, the WRSM drive motor having a rotor wound with coils with a slip ring disposed thereon, a brush mounted to a brush holder to be in contact with the slip ring, and a position sensor mounted to an end portion of the rotor, the noise shield unit comprising:
a shield plate of a magnetic material mounted between the brush holder and the position sensor.

2. The noise shield unit of claim 1, wherein the shield plate is one unit with the brush holder.

3. The noise shield unit of claim 2, wherein the shield plate and the brush holder are insert injection molded.

4. The noise shield unit of claim 2, wherein the shield plate includes:
a connection portion connected to an upper side of the brush holder; and
a shielding portion connected to the connection portion as one unit spaced apart from the brush holder by the connection portion to surround the brush holder between the position sensor and the brush holder.

5. The noise shield unit of claim 4, wherein the shielding portion includes:
a first flat portion; and
a second portion bent toward both sides of the brush holder from both sides of the first portion, respectively.

6. The noise shield unit of claim 1, wherein the shield plate is formed of S45C material.
